(19) United States
(12) Patent Application Publication
(10) Pub. No.: US 2009/0087054 A1
(43) Pub. Date: Apr. 2, 2009

(54) Method and computer-readable code for characterizing a three-dimensional space

(76) Inventors: David Lee Gines, Fort Collins, CO (US); Tracy Kristine Eliasson, Boulder, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/904,733

(22) Filed: Sep. 28, 2007

(51) Int. Cl. G06K 9/00

(52) U.S. Cl. 382/131

(57) ABSTRACT

In one embodiment, a three-dimensional space is characterized by identifying sets of corresponding pixels in a plurality of radiation images. Different ones of the plurality of radiation images correspond to different slices of the three-dimensional space, and each of the sets of corresponding pixels corresponds to a different one of a plurality of x/y-coordinates of the three dimensional space. For each set of corresponding pixels, a pixel that conveys a defined property of the set of corresponding pixels is identified. The three-dimensional space is then characterized by outputting a composite radiation image comprising the identified pixels. Other embodiments are also disclosed.

### BACKGROUND

The integrity of solder joints on a printed circuit assembly are often verified using x-ray technology. Automated three-dimensional (3D) x-ray systems, such as Agilent Technologies, Inc.'s 5DX x-ray system, can automatically locate solder joints of interest, construct 3D representations of the solder joints, and classify the solder joints as good or bad based on various algorithms and user preferences. In a typical 3D imaging mode, raw 3D image data is used to mathematically construct a two-dimensional (2D) “slice” image that is parallel to the surface of a printed circuit assembly and positioned at or above the surface of the printed circuit assembly.

Typically, a single slice image, positioned at or slightly above the surface of a printed circuit assembly, is used by a classification engine of a 3D x-ray system to screen for defects such as open solder joints, shorted solder joints, and insufficient solder joint dimensions. A slice image positioned at or slightly above the surface of a printed circuit assembly is sometimes referred to as a “board-surface slice” or “pad slice”.

For larger solder joints, such as those found in ball-grid arrays, a 3D x-ray system may construct two or three slice images, each of which is positioned at a different height with respect to the surface of a printed circuit assembly. One of the slice images is typically a pad slice, and the other slice images may respectively correspond to the middle of the solder joint the top of the solder joint. When multiple slice images of a solder joint are constructed, each of the slice images is separately analyzed by a classification engine to screen for defects such as open solder joints, shorted solder joints, and insufficient solder joint dimensions.

### BRIEF DESCRIPTION OF THE DRAWINGS

Illustrative embodiments of the invention are illustrated in the drawings, in which:

FIG. 1 illustrates an exemplary method for characterizing a three-dimensional space;

FIG. 2 illustrates an exemplary plurality of radiation images for a three-dimensional space;

FIG. 3 illustrates an exemplary use of the method shown in FIG. 1 to characterize gullwing solder joints on a printed circuit assembly;

FIG. 4 illustrates an exemplary cross-section of a solder joint having a solder void;

FIG. 5 illustrates an exemplary use of the method shown in FIG. 1 to characterize the solder joint shown in FIG. 4; and

FIG. 6 illustrates an exemplary series of steps that may be executed by a computer for the purpose of characterizing at least one solder joint on a printed circuit assembly.

### DETAILED DESCRIPTION

Historically, most defects in and between the solder joints of a printed circuit assembly have been viewable in the pad slice, and defects in larger solder joints have been detectable by constructing and analyzing radiation images of two or three slices of a solder joint. However, the ever-decreasing dimensions of solder joints and the spacing between them means that defects are evermore likely to occur at any height above the surface of a printed circuit assembly. Exemplary types of defects that may occur at any height in or between solder joints include defects “in” solder joints, such as voids and opens, and defects between solder joints, such as shorts. As a result, a way to increase the depth of focus of an x-ray system is needed.

One way to increase an x-ray system's depth of focus is to decrease the vertical spacing and number of slice images that are constructed for a solder joint. However, if the images are analyzed serially, the time needed to classify a solder joint as good or bad increases linearly with the number of images that are analyzed. Alternately, the images may be analyzed in parallel. However, this may place a drain on, or require an upgrade of, an x-ray system's processing resources—thereby increasing the x-ray system's cost.

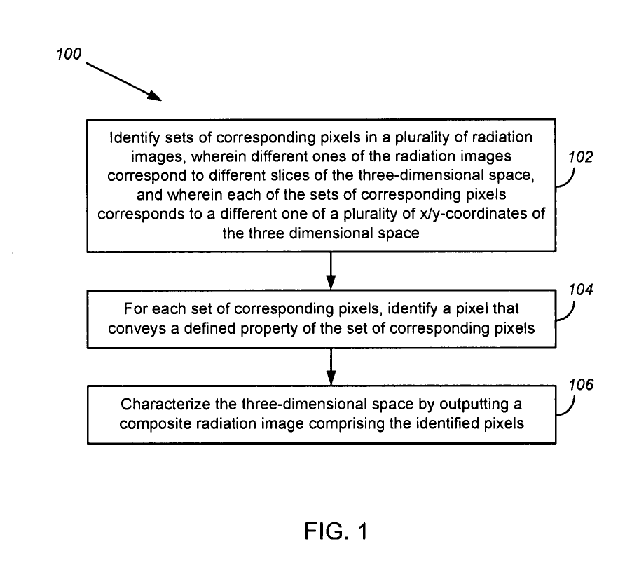

In the above context, FIG. 1 illustrates an exemplary new method 100 for characterizing a three-dimensional space. In one embodiment, the three-dimensional space may include an expected location of at least one solder joint on a printed circuit assembly. In other embodiments, and by way of example, the three-dimensional space may include: an expected location of a glue joint; an expected location of another type of joint; the interior of a box; or any other three-dimensional space that may need to be analyzed for defects or regions of varying composition or density.

The method 100 comprises identifying sets of corresponding pixels in a plurality of radiation images, wherein different ones of the plurality of radiation images correspond to different slices of the three-dimensional space, and wherein each of the sets of corresponding pixels corresponds to a different one of a plurality of x/y-coordinates of the three dimensional space. See, block 102 of FIG. 1. For each set of corresponding pixels, a pixel that conveys a defined property (such as maximum darkness or maximum lightness) of the set of corresponding pixels is identified. See block 104. The three-dimensional space is then characterized by outputting a composite radiation image comprising the identified pixels (at block 106).

By way of example, the plurality of radiation images utilized by the method 100 may take the form of x-ray radiation images, microwave radiation images, acoustic radiation images, or any other type of radiation image that is suitable for characterizing a three-dimensional space of a particular type or composition. Of note, different ones of the plurality of radiation images used by the method 100 correspond to “different” slices of the three-dimensional space. That is, and as will be explained more later in this description, different ones of the plurality of radiation images may correspond to slices having different z-coordinates in an x/y/z coordinate system (although all of the radiation images need not have different z-coordinates), or different ones of the plurality of radiation images may correspond to slices that intersect the three-dimensional space at different angles. This is in contrast to the plurality of “raw” radiation images which may, for example, be acquired and used by a 3D x-ray system to construct the plurality of radiation (or slice) images used by the method 100. The “raw” radiation images that are acquired and used by a 3D x-ray system typically share a common z-coordinate.

In some embodiments, the method 100 may further comprise the step of generating or constructing the plurality of radiation images. In one embodiment, the plurality of radiation images may be constructed by 1) x-raying the three-dimensional space to produce a plurality of two-dimensional x-ray images, each of which corresponds to a different view of the space, then 2) constructing the plurality of radiation images based on the plurality of two-dimensional x-ray images. Such is the case with a 3D x-ray technology such as laminography or computed tomography.

The number of radiation images that are generated via laminogaphy, computed tomography or other radiation-based imaging technology may vary from two to many. In some cases, the method 100 may comprise 1) receiving a user-selected number of radiation images, and 2) generating the plurality of radiation images based on the user-selected number of radiation images. In other cases, the method 100 may comprise 1) receiving a z-coordinate differential, and 2) generating the plurality of radiation images based on the z-coordinate differential. That is, the z-dimension of a three-dimensional space may be divided by a z-coordinate differential (i.e., a desired spacing between radiation images) to determine the number of radiation images in the plurality of radiation images.

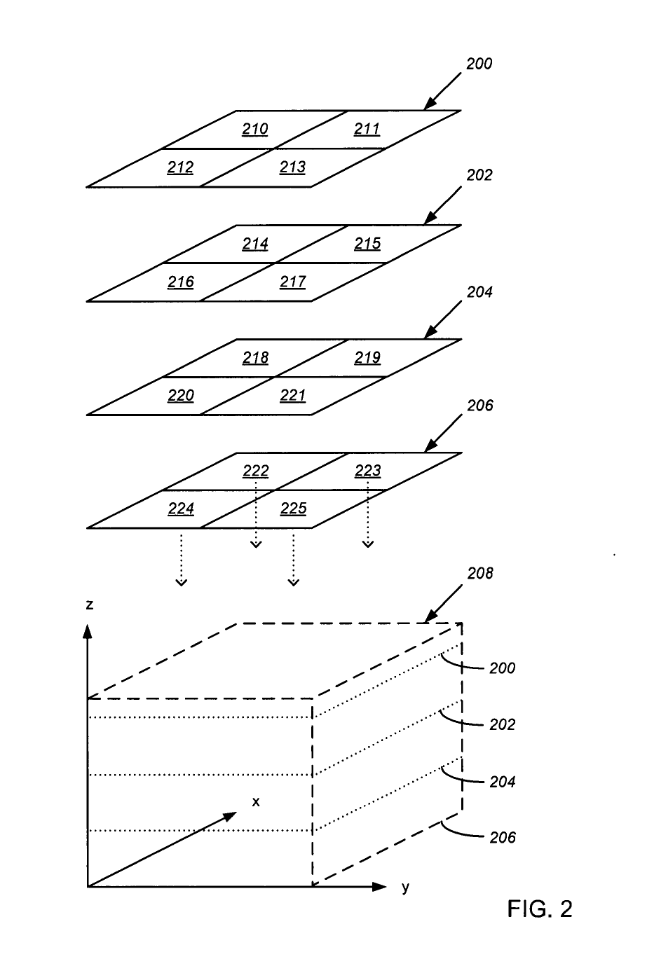

An exemplary plurality of radiation images 200, 202, 204, 206 is shown in FIG. 2. By way of example, the plurality of radiation images 200, 202, 204, 206 consists of four radiation images, and each radiation image 200, 202, 204, 206 consists of four pixels 210-213, 214-217, 218-221, 222-225. Typically, however, the method 100 will be applied to radiation images having thousands or millions of pixels, and the plurality of radiation images may comprise any number of two or more images.

By way of example, the radiation images 200, 202, 204, 206 shown in FIG. 2 correspond to parallel slices of a three-dimensional space 208, with different ones of the radiation images 200, 202, 204, 206 corresponding to different z-coordinates of the three-dimensional space 208. For example, in the context of a printed circuit assembly, the plurality of radiation images 200, 202, 204, 206 could comprise radiation images that intersect one or more solder joints of the printed circuit assembly at different heights above a surface of the printed circuit assembly on which the solder joint(s) are formed.

Also by way of example, each of the radiation images 200, 202, 204, 206 shown in FIG. 2 has a coincident footprint when projected on an x/y-coordinate plane of the three-dimensional space 208. It is therefore a relatively straight-forward task to identify sets of corresponding pixels (such as pixels 212, 216, 220 and 224) in the four images 200, 202, 204, 206, as each set of corresponding pixels will correspond to a different coordinate in the x/y-coordinate plane. However, it is envisioned that, in some radiation systems, radiation images may be generated for non-parallel slices of a three-dimensional space, or radiation images may not have coincident footprints when projected on an x/y-coordinate plane, or radiation images may be acquired at different resolutions. In these cases, sets of corresponding pixels may be determined in various different ways, such as, by 1) projecting each of the radiation images onto an x/y-coordinate plane of the three-dimensional space, and/or 2) identifying sets of corresponding pixels that do not include a pixel from each radiation image (e.g., when radiation images do not have coincident footprints when projected on an x/y-coordinate plane).

After sets of corresponding pixels have been identified (or while they are being identified), a pixel that conveys a defined property of each set is identified. In some embodiments of the method 100, the defined property may be maximum darkness or maximum lightness. Typically, the pixels of radiation images are associated with a grayscale value, such as an 8-bit grayscale value. In these cases, a pixel that conveys maximum darkness may be a pixel having a highest grayscale value, and a pixel that conveys maximum lightness may be a pixel having a lowest grayscale value.

A composite radiation image may be output by the method 100 in various ways. In some embodiments, outputting the composite radiation image may comprise displaying the composite radiation image via a graphical user interface, or saving the composite radiation image to a file

Consider now the application of the method 100 to a printed circuit assembly, wherein the three-dimensional space includes an expected location of at least one solder joint on the printed circuit assembly, wherein the plurality of radiation images are x-ray radiation images, and wherein the “defined property” conveyed by a pixel in a set is darkness. By way of example, the printed circuit assembly may be a loaded printed circuit board or multi-chip module. Because the solder joints of a printed circuit assembly typically pass the fewest x-rays, the darkest pixels in an x-ray radiation image tend to identify the locations of solder joints. Similarly, a composite radiation image comprised of the darkest pixels in a plurality of x-ray radiation images tends to indicate whether solder exists at any x/y-coordinate in a three-dimensional space, regardless of the z-coordinate (or height above the printed circuit assembly) at which the solder exists.

Although a composite radiation image of “darkest pixels” will not definitively indicate whether adjacent x/y-coordinates of a printed circuit assembly are electrically shorted by solder, a composite radiation image of “darkest pixels” is a very good predictor of whether adjacent x/y-coordinates of a printed circuit assembly are shorted by solder. This is because it is unlikely that two solder joints of a printed circuit assembly will occupy a common x/y-coordinate of a printed circuit assembly without also connecting at a common z-coordinate (i.e., without forming a solder bridge, or short, at a common z-coordinate). Given this assumption, the characterizing step of the method 100 may further comprise 1) comparing the composite radiation image to an expected composite radiation image of the three-dimensional space, and 2) based on differences found during the comparison, identifying unwanted electrical shorts to the at least one solder joint. By way of example, unwanted electrical shorts may take the form of shorts between solder joints (including shorts between balls of a ball grid array, and shorts between pins or pads of an integrated circuit); shorts between solder joints and circuit traces; shorts between solder joints and wires; and shorts between solder joints and other circuit components (such as resistors and capacitors).

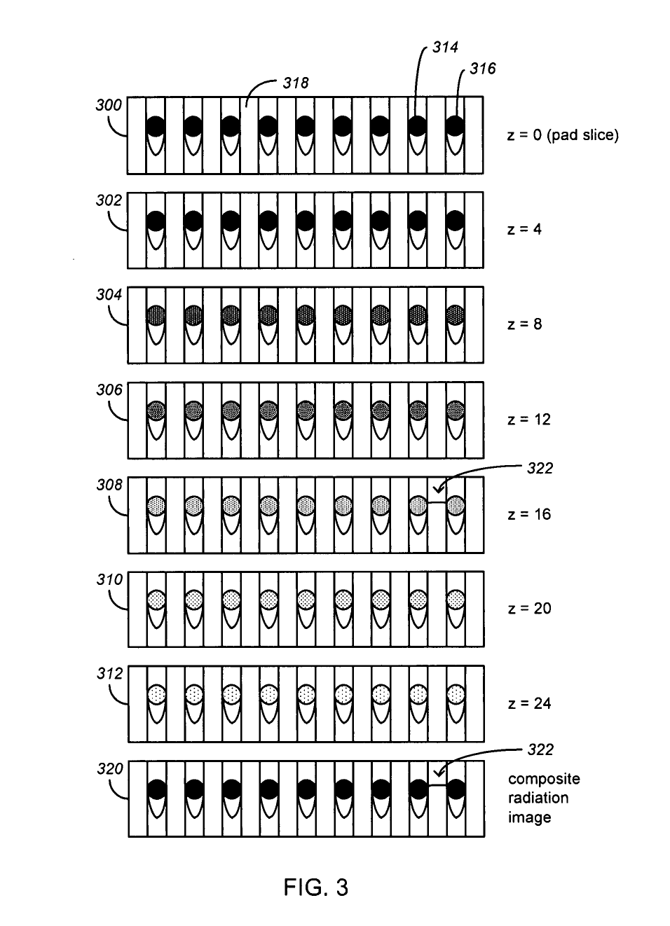

FIG. 3 illustrates an exemplary use of the method 100 shown in FIG. 1 to characterize gullwing solder joints 314, 316 on a printed circuit assembly 318. As shown, several images 300, 302, 304, 306, 308, 310, 312 of the printed circuit assembly 318 and solder joints 314, 316 may be constructed. Although seven (7) are shown, taken at z-heights (z) of z=0, z=4, z=8, z=12, z=16, z=20 and z=24, more or fewer radiation images could be constructed, depending on the desired resolution of defect detection. The darkest pixels of each radiation image 300, 302, 304, 306, 308, 310, 312 are then identified and used to form the composite radiation image 318. Of note, the composite radiation image 318 indicates that an electrical short 320 likely exists between the solder joints 314 and 316 (and as shown in image 308, a short 320 does, in fact, exist).

From the above description of an exemplary application of the method 100 (FIG. 1), one can appreciate that a composite radiation image enables characteristics of a three-dimensional space, such as solder defects, to be determined from a single radiation image, and without the need of an algorithm for searching in the z-dimension. Furthermore, characteristics or defects at multiple z-heights may be found by analyzing only a single radiation image.

In addition to being used to detect unwanted shorts in a printed circuit assembly, a composite radiation image of “darkest pixels” may be used for other fault analysis purposes. For example, a composite radiation image of “darkest pixels” may be used to detect unwanted electrical opens. That is, if an expected composite radiation image indicates that two solder joints should be electrically connected, but an actual composite radiation image indicates that no electrical connection exists (e.g., because none of the pixels are dark enough to indicate the existence of solder), then an unwanted open may be flagged.

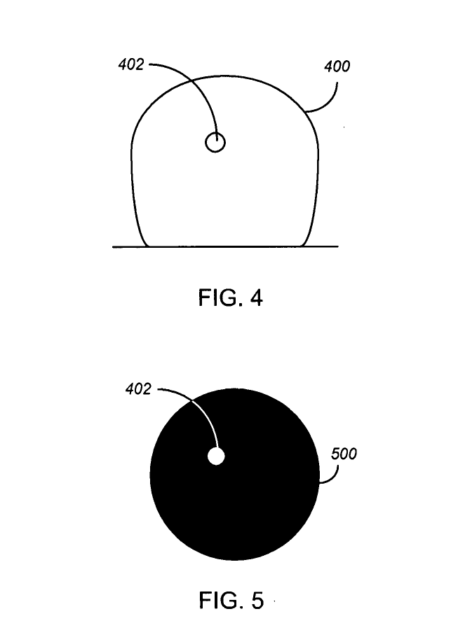

The method 100 may also be configured so that the “defined property” conveyed by a pixel in a set is maximum lightness. Such an embodiment may be used to detect opens (and some shorts) between solder joints, as well as voids and opens in solder joints. For example, a cross-section of a solder joint 400 containing a void 402 is shown in FIG. 4, and a composite radiation image 500 of “lightest pixels” in the solder joint 400 is shown in FIG. 5. As one can see, the composite radiation image 500 identifies the void 402 as a group of lighter pixels within a ring of darker pixels.

Expected composite radiation images may be generated in various ways. In one embodiment, an expected composite radiation image for a printed circuit assembly (or at least a space above the printed circuit assembly including one or more solder joints) may be generated from computer-based design data for the printed circuit assembly. In another embodiment, the expected composite radiation image may be generated by irradiating a known-good printed circuit assembly.

Preferably, the method 100 is implemented by means of a computer. The method 100 may therefore be implemented by means of a computer executing computer-readable code stored on a computer-readable medium. By way of example, the computer-readable medium may take the form of any number or mixture of fixed or removable media (such as one or more fixed disks, random access memories (RAMs), read-only memories (ROMs), or compact discs), at either a single location or distributed over a network. The computer-readable code may, for example, take the form of software or firmware.

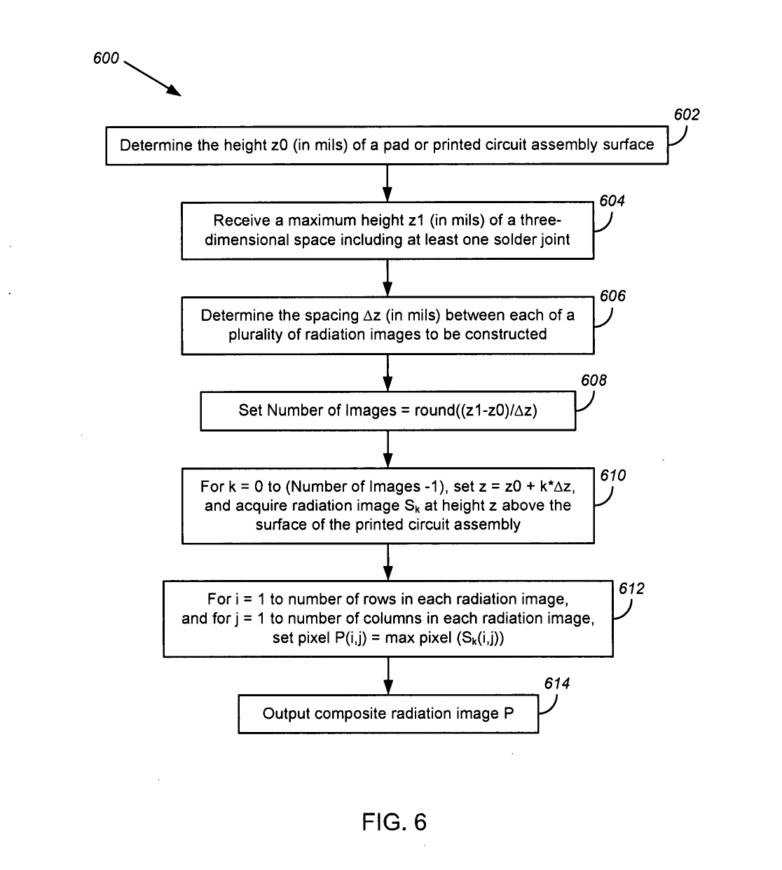

Given that the method 100 may be implemented by means of a computer, FIG. 6 illustrates an exemplary series of steps that may be executed by a computer for the purpose of characterizing at least one solder joint on a printed circuit assembly. The steps include: determining the height z0 (in mils) of a pad or printed circuit assembly surface (at block 602); receiving or determining a maximum height z1 (in mils) of a three-dimensional space including at least one solder joint (at block 604); and determining the spacing Δz (in mils) between each of a plurality of radiation images to be constructed (at block 606). The “Number of Images” to be constructed is then set to equal round ((z1−z0)/Δz), where “round” is a function that rounds to the nearest integer. See, block 608. Subsequently, for k=0 to (Number of Images−1), z is set to (z0+k*Δz), and a radiation image Sₖ is acquired at each height z above the surface of the printed circuit assembly (at block 610). Then, for i=1 to the number of rows in each radiation image, and for j=1 to the number of columns in each radiation image, the pixel P(i,j) is given a defined property of a set of pixels including the pixels (Sₖ(i,j). By way of example, the defined property may be “maximum darkness”, and a function such as P(i,j)=(max pixel (Sₖ(i,j))) may be implemented. See, block 612. Finally, a composite radiation image P may be output (at block 614).

What is claimed is:

1. A method of characterizing a three-dimensional space, comprising:
identifying sets of corresponding pixels in a plurality of radiation images, wherein different ones of the plurality of radiation images correspond to different slices of the three-dimensional space, and wherein each of the sets of corresponding pixels corresponds to a different one of a plurality of x/y-coordinates of the three dimensional space;
for each set of corresponding pixels, identifying a pixel that conveys a defined property of the set of corresponding pixels; and
characterizing the three-dimensional space by outputting a composite radiation image comprising the identified pixels.

2. The method of claim 1, wherein the plurality of radiation images is a plurality of x-ray images.

3. The method of claim 1, wherein the plurality of radiation images is a plurality of acoustic radiation images.

4. The method of claim 1, wherein different ones of the plurality of radiation images correspond to different z-coordinates of the three-dimensional space.

5. The method of claim 1, wherein the defined property is darkness.

6. The method of claim 1, wherein the three-dimensional space includes an expected location of at least one solder joint on a printed circuit assembly, wherein the plurality of radiation images is a plurality of x-ray radiation images, wherein the defined property is darkness.

7. The method of claim 6, wherein the plurality of radiation images comprise radiation images that intersect the at least one solder joint at different heights above a surface of the printed circuit assembly on which the at least one solder joint is formed.

8. The method of claim 6, wherein characterizing the three-dimensional space further comprises:
comparing the composite radiation image to an expected composite radiation image of the three-dimensional space; and
based on differences found during the comparison of the composite radiation image to the expected composite radiation image, identifying unwanted electrical shorts to the at least one solder joint.

9. The method of claim 8, further comprising:
generating the expected composite radiation image from computer-based design data for the printed circuit assembly.

10. The method of claim 1, wherein the three-dimensional space includes an expected location of at least one solder joint on a printed circuit assembly, wherein the plurality of radiation images is a plurality of x-ray radiation images, wherein the defined property is lightness.

11. The method of claim 1, wherein the different slices are parallel slices.

12. The method of claim 1, wherein the three-dimensional space includes an expected location of a glue joint.

13. The method of claim 1, further comprising:
x-raying the space to produce a plurality of two-dimensional x-ray images corresponding to different views of the space; and
constructing the plurality of radiation images based on the plurality of two-dimensional x-ray images.

14. The method of claim 13, further comprising:
receiving a user-selected number of radiation images; and
generating the plurality of radiation images based on the user-selected number of radiation images.

15. The method of claim 13, further comprising:
receiving a z-coordinate differential; and
generating the plurality of radiation images based on the z-coordinate differential.

16. The method of claim 1, wherein outputting the composite radiation image comprises displaying the composite radiation image via a graphical user interface.

17. The method of claim 1, wherein outputting the composite radiation image comprises saving the composite radiation image to a file.

18. A computer-readable medium having computer-readable code stored thereon, the computer-readable code being executable by a computer to characterize a three-dimensional space, and the computer-readable code comprising:
code to cause the computer to identify sets of corresponding pixels in a plurality of radiation images, wherein different ones of the plurality of radiation images correspond to different slices of the three-dimensional space, and wherein each of the sets of corresponding pixels corresponds to a different one of a plurality of x/y-coordinates of the three dimensional space;
code to cause the computer to, for each set of corresponding pixels, identify a pixel that conveys a defined property of the set of corresponding pixels; and
code to cause the computer to characterize the three-dimensional space by outputting a composite radiation image comprising the identified pixels.

19. The computer-readable media of claim 18, wherein the three-dimensional space includes an expected location of at least one solder joint on a printed circuit assembly, wherein the plurality of radiation images is a plurality of x-ray radiation images, wherein the defined property is darkness.

20. The computer-readable media of claim 18, wherein the three-dimensional space includes an expected location of at least one solder joint on a printed circuit assembly, wherein the plurality of radiation images is a plurality of x-ray radiation images, wherein the defined property is lightness.
